(19) United States
(12) Patent Application Publication
(10) Pub. No.: US 2021/0251731 A1
(43) Pub. Date: Aug. 19, 2021

(54) METHOD FOR DENTURE ATTACHMENT

(71) Applicants: AARON DAGENAIS, WAXAHACHIE, TX (US); JAYMI STIVASON, MIDLOTHIAN, TX (US)

(72) Inventors: AARON DAGENAIS, WAXAHACHIE, TX (US); JAYMI STIVASON, MIDLOTHIAN, TX (US)

(21) Appl. No.: 16/795,278

(22) Filed: Feb. 19, 2020

(51) Int. Cl. A61C 13/235; A61C 13/107

(52) U.S. Cl. CPC A61C 13/235; A61C 13/0001

(57) ABSTRACT

A method for positioning a tissue-implanted magnetic member in an edentulous ridge of a patient and positioning a corresponding magnetic member in a removable prosthesis. The method includes forming an incision into an edentulous ridge based on a first set of markings on a mucosa surface; positioning a first magnetic member into the incision; forming a divot into an intaglio surface of a denture based on a second set of markings; and positioning the second magnetic member into the formed divot. Furthermore, a piercing tool assembly is provided for making an incision in positioning a tissue-implanted magnetic member in an edentulous ridge.

### BACKGROUND OF THE INVENTION

### 1. Field of the Invention

The present application relates to prosthetics, and more particularly to denture prosthetics.

### 2. Description of Related Art

The use of denture prosthetics is well known for the replacement of missing teeth. Various methods for retaining dentures having been developed: suction-retained, intra-mucosal retained, tooth-retained, and implant-retained. Traditional dentures rely on mechanical retention achieved through flanges and suction; however, this method is known to fail at achieving satisfactory retention and fail to replicate the natural dentition. Many patients are forced to use dental adhesives to improve retention and chewing capability; however, dental adhesives are unappealing, sticky, and are a short-term solution. Furthermore, some patients can be allergic to the ingredients in the adhesives.

Intra-mucosally retained dentures rely on a metal implant that is placed below the mucosa but not in the bone. The implant has a corresponding attachment inside the denture that allows the denture to lock into place; however, this approach is expensive and highly technique sensitive.

Tooth-retained dentures rely on attachments added to retained teeth, typically canines, that have a corresponding attachment in the denture. These attachments, typically called precision attachments, lock together to stabilize the denture. The denture is then retained by the roots of the retained teeth wherein suction and mechanical retention designed into the denture provide ancillary support rather than primary support. Limitations of this method of denture retention are often the canines are already missing or are otherwise poor abutments to retain a denture.

Dental implants are also used to retain dentures. These work with either attachments or a bar mechanisms to support the denture. The disadvantages of dental implants are that they are expensive, they cannot be used in medically compromised patients, they require a long duration for surgery, and they have highly technique sensitive fabrication procedures. Furthermore, patients receiving implants must be compliant for frequent recall visits, and patients who have myocardial infarction, valvular prosthesis, severe renal disease, uncontrolled diabetes, advanced and untreated osteoporosis, acquired immunodeficiency disorders, hematological disorders, liver disorders, or kidney disorders contraindicate the use of dental implants. In some instances, patients that have a knife-edge alveolar ridge or insufficient alveolar bone to place an implant are also excluded from receiving dental implants.

While there are several known solutions for dental prosthesis, many short comings remain. It is therefore desired to develop a denture solution that is more affordable, less technique-sensitive, and has fewer contraindications than the dental prosthetics known in the art.

### BRIEF SUMMARY OF THE INVENTION

It is an object of the present application to provide a method for positioning a tissue-implanted magnetic member in an edentulous ridge of a patient and positioning a corresponding magnetic member in a removable prosthesis, thereby providing a selectively removable prosthesis that magnetically couples to the edentulous ridge. The method includes forming an incision into an edentulous ridge based on a first set of markings on a mucosa surface of the edentulous ridge, where then a first magnetic member is positioned into the incision. The method additionally includes forming a divot into an intaglio surface of a denture based on a second set of markings and positioning the second magnetic member into the formed divot.

Another object of the present invention is to provide a piercing tool assembly used for making an incision in positioning a tissue-implanted magnetic member in an edentulous ridge. The assembly includes a forked member having a set of guide holes and measurement indicia measuring from the set of guide holes; a jack screw in communication with the forked member; a knob in communication with the jack screw; a guide rod in communication with the forked member and a bracket having an aperture wherein the jack screw passes through the aperture; and a piercing member configured to pass through the set of guide holes of the forked member, wherein the piercing member is in communication with the jack screw and the guide rod through a respective first and second aperture, and wherein the piercing member is driven by rotation of the jack screw and corresponding screw threads between the jack screw and the piercing member.

Ultimately the invention may take many embodiments. In these ways, the present invention overcomes the disadvantages inherent in the prior art.

The more important features have thus been outlined in order that the more detailed description that follows may be better understood and to ensure that the present contribution to the art is appreciated. Additional features will be described hereinafter and will form the subject matter of the claims that follow.

Many objects of the present application will appear from the following description and appended claims, reference being made to the accompanying drawings forming a part of this specification wherein like reference characters designate corresponding parts in the several views.

Before explaining at least one embodiment of the present invention in detail, it is to be understood that the embodiments are not limited in its application to the details of construction and the arrangements of the components set forth in the following description or illustrated in the drawings. The embodiments are capable of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the various purposes of the present design. It is important, therefore, that the claims be regarded as including such equivalent constructions in so far as they do not depart from the spirit and scope of the present application.

### BRIEF DESCRIPTION OF THE DRAWINGS

The novel features believed characteristic of the application are set forth in the appended claims. However, the application itself, as well as a preferred mode of use, and further objectives and advantages thereof, will best be understood by reference to the following detailed description when read in conjunction with the accompanying drawings, wherein:

FIG. 1 is a flowchart depicting operational steps for positioning magnetic co-members for a denture and a patient, in accordance with an embodiment of the present invention;

FIG. 2 is a bottom view of a denture illustrating a first set of placed markings for positioning a first magnetic member;

FIG. 3 is a top view of an edentulous ridge of the patient illustrating positioning a second magnetic member based on a second set of placed markings;

FIG. 4 is a cross section view illustrating the denture of FIG. 2 positioned on the edentulous ridge of FIG. 3;

FIG. 5 is side view of a piercing tool assembly for denture attachment according to the present application; and

FIG. 6 is a side view inside a mouth of a patient illustrating use of the piercing tool assembly of FIG. 5.

While the embodiments and method of the present application is susceptible to various modifications and alternative forms, specific embodiments thereof have been shown by way of example in the drawings and are herein described in detail. It should be understood, however, that the description herein of specific embodiments is not intended to limit the application to the particular embodiment disclosed, but on the contrary, the intention is to cover all modifications, equivalents, and alternatives falling within the spirit and scope of the process of the present application as defined by the appended claims.

### DETAILED DESCRIPTION OF THE INVENTION

Illustrative embodiments of the preferred embodiment are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

In the specification, reference may be made to the spatial relationships between various components and to the spatial orientation of various aspects of components as the devices are depicted in the attached drawings. However, as will be recognized by those skilled in the art after a complete reading of the present application, the devices, members, apparatuses, etc. described herein may be positioned in any desired orientation. Thus, the use of terms to describe a spatial relationship between various components or to describe the spatial orientation of aspects of such components should be understood to describe a relative relationship between the components or a spatial orientation of aspects of such components, respectively, as the embodiments described herein may be oriented in any desired direction.

The assembly and method in accordance with the present invention overcomes one or more of the above-discussed problems associated with denture prosthetics. In particular, the method of the present invention is a method for positioning a tissue-implanted magnetic member in an edentulous ridge of a patient and positioning a corresponding magnetic member in a removable prosthesis, thereby providing a selectively removable prosthesis that magnetically couples to the edentulous ridge, thus providing a simple, affordable dental prosthesis solution that has few contraindication for the patient. As used herein, an edentulous ridge is an alveolar ridge with all teeth, or a subset of teeth, are missing. Furthermore, a piercing tool assembly is presented that is used for forming an incision to position the tissue-implanted magnetic member.

The method and system will be understood from the accompanying drawings, taken in conjunction with the accompanying description. Several embodiments of the method and system may be presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless otherwise described.

The method and system of the present application is illustrated in the associated drawings. As used herein, “system” and “assembly” are used interchangeably. It should be noted that the articles “a”, “an”, and “the”, as used in this specification, include plural referents unless the content clearly dictates otherwise. Additional features and functions are illustrated and discussed below.

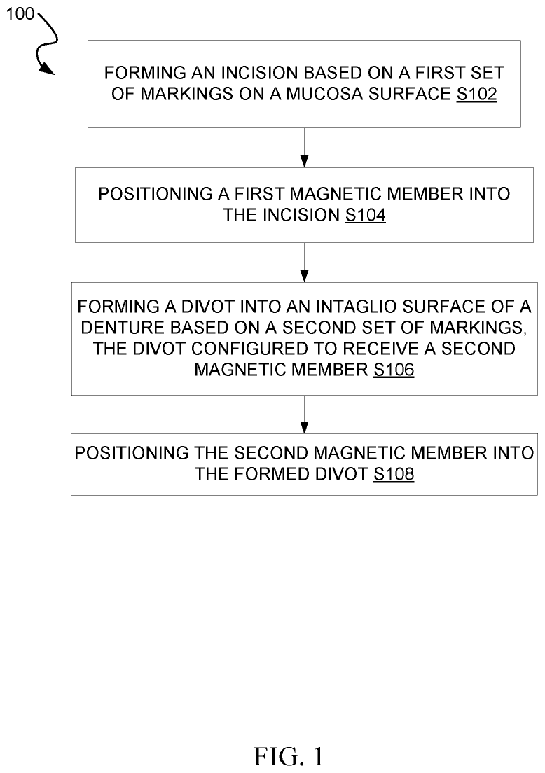

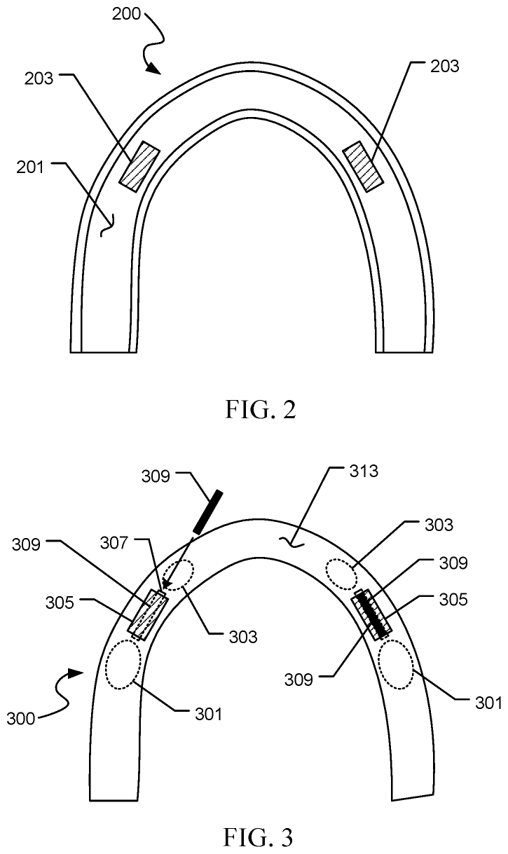

Referring now to the drawings wherein like reference characters identify corresponding or similar elements in form and function throughout the several views. FIG. 1 illustrates a flowchart for depicting operational steps for positioning magnetic co-members for a denture and a patient. FIGS. 2-6 illustrate various views of the denture and/or the edentulous ridge of the patient during various steps of the flowchart depicted in FIG. 1.

FIG. 1 is flowchart 100 depicting operational steps for positioning magnetic co-members for a denture and a patient performed by a dental prothesis professional, herein designated as a “user”, in accordance with an embodiment of the present invention.

In step S102, a user forms an incision based on a first set of markings on a mucosa surface. In this embodiment, the user forms an incision into an edentulous ridge of a patient based on a first set of markings on a mucosa surface of the edentulous ridge.

In one embodiment, the first set of markings are produced by the user placing a second set of markings on an intaglio surface of a denture using an indelible pencil, the second set of markings corresponding to placement of a first magnetic member in the denture. The user then copies the second set of markings from the intaglio surface of the denture to the mucosa surface of the edentulous ridge to form the first set of markings by positioning the denture on the edentulous ridge, wherein the intaglio surface and the mucosa surface are in flush contact. For example, in reference to FIG. 1 illustrating a bottom view of denture 200 and FIG. 2 illustrating a top view of edentulous ridge 300. In FIG. 1, the user places markings 203 on intaglio surface 201 of denture 200 with an indelible pencil. The user copies markings 203 to the mucosa surface of the edentulous ridge of the patient by positioning denture 200 onto the edentulous ridge. In reference to FIG. 2, the markings 305 located on mucosa surface 313 of edentulous ridge 300 are copied from markings 203 of FIG. 1.

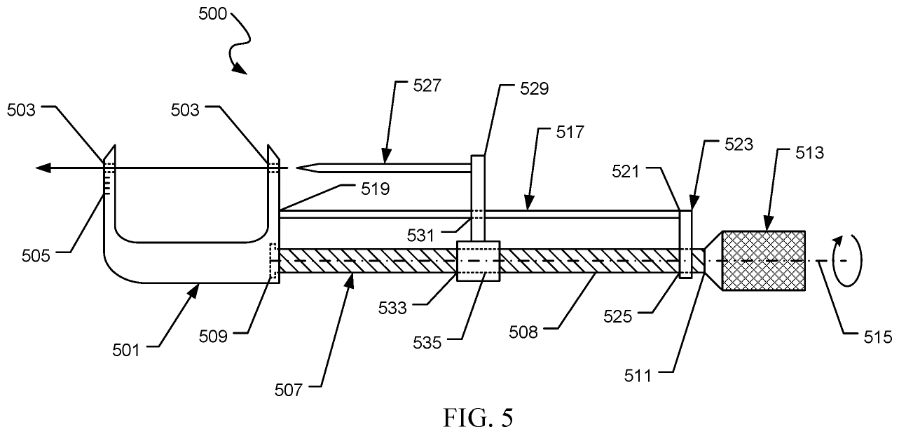

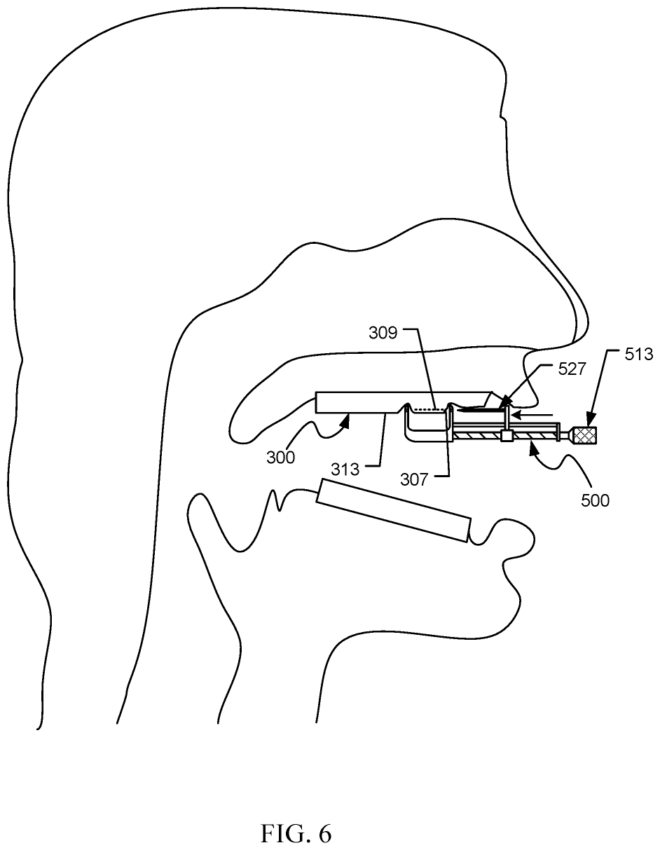

In this embodiment, the user forms incision 307 based on markings 305, subsequently forming incision canal 309. In some embodiments, the user forms incision 307 and incision canal 309 using a piercing member, wherein the piercing member pierces mucosa surface 313 at incision 309 and enters within edentulous ridge 300 in a posterior direction (relative to the patient) along edentulous ridge 300. Piercing member and its use are further detailed and described with reference to FIGS. 5 and 6.

In some embodiments, the user anesthetizes the edentulous ridge prior to making the incision.

In a preferred embodiment, markings 305 (and corresponding markings 203) for positioning a magnetic member are located between first molar 301 and canine 303, wherein a subsequent magnetic member is positioned between first molar 301 and canine 303. In general, first molar 301 and canine 303 are positions of where a first molar and a canine teeth are anatomically located along an edentulous ridge; however, it should be realized that the first molar and the canine teeth may or may not be present during this procedure. Furthermore, it should also be appreciated that markings 305 are not limited to the location between first molar 301 and canine 303. In other words, markings 305 for placing a magnetic member may be located along any position along edentulous ridge 300 having at least a depth of 3 mm of mucosa tissue.

In a more general sense, the magnetic member (i.e., magnetic member 309) is positioned between in edentulous ridge 300 having at least a depth of 3 mm of mucosa tissue, and/or ideally positioned between first molar 301 and canine 303.

While denture 200 is shown in FIG. 2 as a full denture to replace an entire set of teeth on an edentulous ridge, it should be appreciated that a denture may be configured to replace only a subset of teeth.

In step S104, the user positions a first magnetic member into the incision. In this embodiment, the user positions magnetic member 309 into incision 307 wherein the position of magnetic member 309 corresponds to markings 305. In this embodiment, magnetic member 309 is positioned parallel to edentulous ridge 300 within incision canal 309. Once magnetic member 309 is in position, the user sutures the incision.

In general, a magnetic member is a device capable of producing magnetic fields and/or is capable of being influenced by a magnetic force. In other words, a magnetic member (i.e., a first magnetic member) can be a magnet, a ferromagnetic device, or a paramagnetic device. Furthermore, a magnetic co-member (i.e., a second magnetic member) is a device capable being influenced by the magnetic force that may arise mutually between the magnetic member and the magnetic co-member. For example, the magnetic member and the magnetic co-member may be both magnets that mutually attract, the magnetic member may be a magnet and the magnetic co-member is a ferromagnetic/paramagnetic device that mutually attract, or the magnetic member may be a ferromagnetic/paramagnetic device and the magnetic co-member is a magnet that mutually attract.

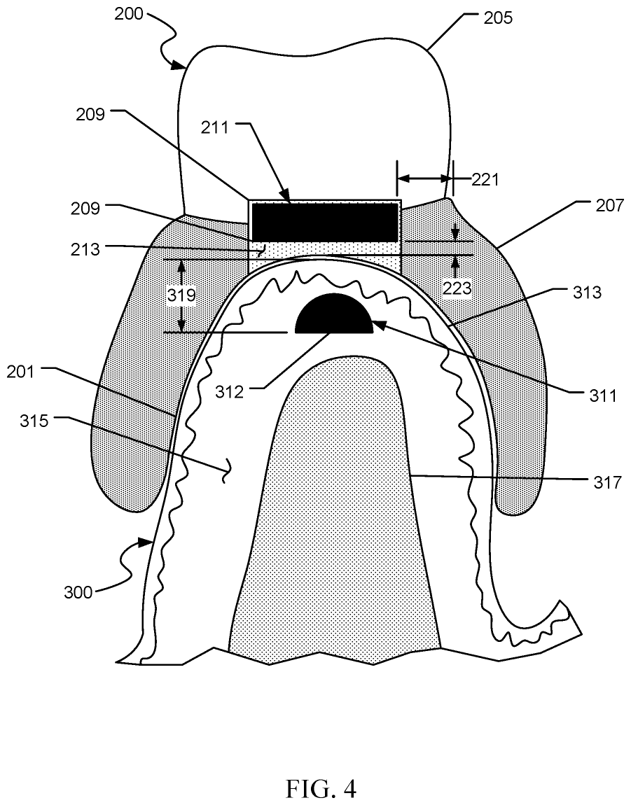

In reference to FIG. 4, a cross section view of denture 200 positioned on edentulous ridge 300 is depicted. In this figure, edentulous ridge 300 is comprises mucosa tissue (i.e., mucosa 315), corresponding mucosa surface 313, and bone 317.

In one embodiment, magnetic member 309 has a semi-circular cross-section that conforms to mucosa surface 313 of edentulous ridge 300. In one embodiment, magnetic member 309 may be positioned in edentulous ridge 300 (i.e., within mucosa 315) at a depth less than 2 mm from mucosa surface 313. In FIG. 4, distance 319 measuring from mucosa surface 313 to distal side 312 of magnetic member 311 is less than 2 mm. In a preferred embodiment, distance 319 is between 1 mm-1.5 mm.

In an alternative embodiment, instead of the user placing markings 203 and copying the markings to edentulous ridge 300 to make markings 305, the user positions magnetic member 309 into the incision, places markings 305 on mucosa surface 313 of edentulous ridge 300 using an indelible pencil, wherein markings 305 correspond to a location of the positioned magnetic member 309, and then copies markings 305 to intaglio surface 201 of denture 200 to form markings 203 by positioning denture 200 on edentulous ridge 300. In this embodiment, the transfer of markings after positioning magnetic member 309 ensures that any error in positioning magnetic member 309 is correctly reflected and marked on denture 200 for positioning a corresponding magnetic co-member.

In step S106, the user forms a divot into an intaglio surface of a denture based on a second set of markings, the divot configured to receive a second magnetic member. In this embodiment, the user forms a divot into intaglio surface 201 based on markings 203, the divot configured to receive a second magnetic member. In reference to FIG. 4, denture 200 further comprises tooth 205, dental mucosa surface 207, divot 209, magnetic member 211, and chairside acrylic 213. In this embodiment, the user extracts portions of denture 200 along intaglio surface 201 to form divot 209, wherein divot 209 corresponds to markings 203 as illustrated in FIG. 2. In one embodiment, the user forms divot 209 using a dental bur.

In step S108, the user positions the second magnetic member into the formed divot. In this embodiment, the user positions magnetic member 211 into divot 209 and fills divot 209, containing magnetic member 211, with chairside hard acrylic (i.e., chairside acrylic 213), thereby permanently coupling magnetic member 211 to denture 200. In one embodiment, a distance between magnetic member 211 and dental mucosa surface 207 is greater than or equal to 0.5 mm. In other words, in reference to FIG. 4, distance 221 is greater than or equal to 0.5 mm. In one embodiment, a submerged distance between a surface of magnetic member 211 (i.e., surface 209) and intaglio surface 201 is less than or equal to 0.5 mm, wherein surface 209 is a side of magnetic member 211 that is proximate to intaglio surface 201. In other words, in reference to FIG. 4, distance 223 is less than or equal to 0.5 mm.

Now in reference to FIG. 5, a side view of piercing tool assembly 500 is depicted, according to an embodiment of the present invention.

In general, piercing tool assembly 500 is a tool used for forming incision 307 and incision canal 309 in edentulous ridge 300. Piercing tool assembly 500 comprises, but is not limited to, forked member 501, jack screw 507, knob 513, guide rod 517, and piercing member 527.

Forked member 501 has guide holes 503 configured to receive piercing member 527. Furthermore, forked member 501 may optionally have measurement indicia 505 that measure from guide holes 503 along forked member 501.

Jack screw 507 has end 509 and end 511 with male threads 508 running along jack screw 507 between ends 509 and 511. End 511 is in communication with knob 513. End 509 of jack screw 507 is in communication with forked member 501, wherein jack screw 507 is configured to rotate about screw axis 515 relative to forked member 501.

Guide rod 517 has end 519 and end 521. End 519 is in communication with forked member 501. End 521 is in communication with bracket 523, wherein bracket 523 has aperture 525. Jack screw 507 passes through aperture 525.

Piercing member 527 is in communication with bracket 529 having aperture 531 and aperture 533, wherein guide rod 517 passes through aperture 531, and wherein jack screw 507 passes through aperture 533. Furthermore, aperture 533 has female threads 535 configured to be driven by male threads 508 of jack screw 507.

In operating piercing tool assembly 500, the user selectively advances and retreats piercing member 527 through guide holes 503 by turning knob 513 about axis 515.

Now referring to FIG. 6, a side view inside a mouth of a patient illustrating use of piercing tool assembly 500 is depicted.

In this figure, piercing tool assembly 500 is positioned such that forked member 501 is depressed against mucosal surface 313 of edentulous ridge 300 to a desired depth. The user may use indicia 505 to determine the desired depth. Once a desired depth is reached, the user forms incision 307 and incision canal 309 by turning knob 513, thereby screwing piercing member 527 in a posterior direction relative to the patient, whereby piercing member 527 penetrates mucosa surface 313 to form the incision. In this figure, the piercing tool assembly 500 is applied to an alveolar ridge of a maxilla of the patient, however it should be appreciated that the method (Steps S102-S108) and assembly stated herein may also but applied to alveolar ridge of a mandible of the patient.

The particular embodiments disclosed above are illustrative only, as the application may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. It is apparent that an application with significant advantages has been described and illustrated. Although the present application is shown in a limited number of forms, it is not limited to just these forms, but is amenable to various changes and modifications without departing from the spirit thereof.

What is claimed is:

1. a method for denture attachment, the method comprising:
forming an incision into an edentulous ridge based on a first set of markings on a mucosa surface of the edentulous ridge;
positioning a first magnetic member into the incision;
forming a divot into an intaglio surface of a denture based on a second set of markings, the divot configured to receive a second magnetic member; and
positioning the second magnetic member into the formed divot.

2. The method of claim 1, further comprising:
placing the second set of markings on the intaglio surface of a denture with an indelible pencil; and
positioning the denture on the edentulous ridge, thereby copying the second set of markings from the intaglio surface of the denture to the mucosa surface of the edentulous ridge to form the first set of markings.

3. The method of claim 1, further comprising:
placing a third set of markings on the mucosa surface of the edentulous ridge with an indelible pencil, the third set of markings corresponding to a location of the positioned first magnetic member; and
positioning a denture on the edentulous ridge, thereby copying the third set of markings from the mucosa surface to the intaglio surface to form the second set of markings.

4. The method of claim 1, further comprising anesthetizing the edentulous ridge.

5. The method of claim 1, wherein the first magnetic member is a magnet.

6. The method of claim 5, wherein the second magnetic member is a magnet.

7. The method of claim 5, wherein the second magnetic member is a ferromagnetic device.

8. The method of claim 1, wherein the second magnetic member is a magnet.

9. The method of claim 8, wherein the first magnetic member is a ferromagnetic device.

10. The method of claim 1, wherein the first magnetic member is positioned in the edentulous ridge at a depth less than 2 mm from the mucosa surface.

11. The method of claim 1, wherein the first magnetic member is positioned between a first molar and a canine.

12. The method of claim 1, wherein the first magnetic member is positioned in the edentulous ridge, the edentulous ridge having at least a depth of 3 mm of mucosa tissue.

13. The method of claim 1, wherein forming the incision into the edentulous ridge is performed by a piercing member in a posterior direction.

14. The method of claim 1, wherein the first magnetic member is positioned parallel to the edentulous ridge.

15. The method of claim 1, wherein the first magnetic member has a semi-circular cross-section that conforms to the mucosa surface of the edentulous ridge.

16. The method of claim 1, wherein a distance between the second magnetic member and a mucosa surface of the denture is greater than or equal to 0.5 mm.

17. The method of claim 1, wherein a submerged distance between a surface of the second magnetic member and the intaglio surface is less than or equal to 0.5 mm, wherein the surface of the second magnetic member is a side proximate to the intaglio surface.

18. The method of claim 1, wherein positioning the second magnet further comprises filling the divot containing the magnet with chairside hard acrylic, thereby coupling the second magnet to the denture.

19. A piercing tool assembly, the assembly comprising:
a forked member having a set of guide holes, the forked member having measurement indicia measuring from the set of guide holes;
a jack screw having a first end and a second end, the jack screw having male threads, the first end in communication with a knob, the second end in communication with the forked member, the jack screw configured to rotate about a screw axis relative to the forked member;
a guide rod having a first end and a second end, the first end in communication with the forked member, the second end in communication with a bracket having an aperture, the jack screw passing through the aperture; and
a piercing member, the set of guide holes of the forked member configured to receive the piercing member, the piercing member in communication with a bracket having a first aperture and a second aperture, the guide rod passing through the first aperture, the jack screw passing through the second aperture, the second aperture having female screw threads configured to receive the male threads of the jack screw.

20. A method for denture attachment, the method comprising:
obtaining the piercing tool assembly of claim 19;
forming an incision into an edentulous ridge based on a first set of markings on a mucosa surface of the edentulous ridge, wherein forming the incision into the edentulous ridge is performed by turning the knob, thereby screwing the piercing member towards a posterior direction;
positioning a first magnetic member into the incision;
forming a divot into an intaglio surface of the denture based on a second set of markings, the divot configured to receive a second magnetic member; and
positioning the second magnetic member into the formed divot.
